(19) United States
(12) Patent Application Publication
(10) Pub. No.: US 2004/0170848 A1
(43) Pub. Date: Sep. 2, 2004

(54) Corrosion inhibiting composition for metals

(75) Inventors: Robert J. Ludwig, Brunswick, OH (US); Shane F. Lofland, Mogadore, OH (US); William E. Rosenberg, SR., Sanibel, FL (US)

Correspondence Address: Daniel J. Hudak, HUDAK, SHUNK & FARINE CO. LPA, 2020 Front Street, Suite 307, Cuyahoga Falls, OH, 44221, US

(73) Assignee: COLUMBIA CHEMICAL CORPORATION

(21) Appl. No.: 10/376,377

(22) Filed: Feb. 28, 2003

(51) Int. Cl. B32B 9/00; B32B 15/04

(52) U.S. Cl. 428/470

(57) ABSTRACT

A corrosion inhibiting composition for coating an article or substrate such as a metal, metal coating, chromated metal coating, and the like comprises a film-forming compound such as a wax or a polymer, and a sulfide salt or thio compound or a derivative of a thio compound.

### FIELD OF THE INVENTION

This invention relates to a composition for treating metal substrates or surfaces to increase corrosion resistance, and more particularly for metals comprising zinc, zinc alloys, or cadmium, or combinations thereof.

### BACKGROUND OF THE INVENTION

Surfaces of zinc, zinc alloys, and cadmium become more corrosion resistant when treated in a solution containing chromium ions. These solutions are commonly called chromates. A measure of corrosion resistance of such chromating solutions is a salt spray test according to ASTM B-117 protocol wherein a plated and passivated part is subjected to a 5% salt spray at 35° C. and 100% humidity. The time is measured to oxidize 5 to 10% of the surface to white rust.

A variety of chromium containing aqueous solutions have heretofore been used or proposed for treating zinc, zinc alloy and cadmium surfaces for improving the corrosion resistance properties thereof. Such treating solutions in the past contained chromium in the hexavalent state and in more recent years the chromium constituent has been in the trivalent state. The reduced toxicity of trivalent chromium and the increased simplicity and efficiency in treating waste effluents containing trivalent chromium has occasioned an increased commercial use of treating solutions in which the chromium constituent is entirely in the trivalent state. Examples of U.S. Patents describing the use of trivalent chromating solutions include U.S. Pat. Nos. 3,843,430, 3,932,198, 4,263,059, 4,171,231, 4,349,392, 4,578,122, and 5,415,702. Such prior art trivalent chromating solutions have been found to be somewhat less effective than the hexavalent chromates in imparting good corrosion resistance to zinc, zinc alloy and cadmium surfaces treated, and there has been a continuing need for further improvement in passivating treatment solutions and processes. An exception to this is the trivalent chromating process is disclosed in U.S. Pat. No. 6,287,704. This patent claims a conversion layer having a thickness of approximately 100 nm to 1000 nm that provides corrosion protection of 100 to 1000 hours in the salt spray test ASTM B-117. This process is expensive to operate due to the extremely high concentration of trivalent chromium ions required.

Attempts have been made to introduce passivating solutions that do not contain chromium at all. U.S. Pat. No. 4,359,347 discloses a solution containing an oxidizing agent and a combination of iron and cobalt ions present in an amount effective to activate the bath and promote the formation of a passivate film on the metal substrate. U.S. Pat. No. 6,270,884 discloses a water-reducible, chrome-free coating containing an organofunctional silane. None of these processes have been able to duplicate the results of chromium containing solutions because sufficient corrosion resistance is not provided.

### SUMMARY OF THE INVENTION

This invention provides an extremely thin corrosion inhibiting composition coating for metal substrates. The use of sulfur containing compounds as inhibitors is achieved by sealing them on the surface of a metal by applying a film comprising an organic film forming wax or synthetic polymer or an inorganic film forming compound. Since the wax or polymer or inorganic film forming compound is only functioning as a means to keep the sulfur containing compound on the surface of the metal, the thickness of the coating can be minimal.

In the case of zinc plated steel, zinc alloy plated steel, and cadmium plated steel this invention provides corrosion resistance to the plated surface without the use of chromium containing passivates. This invention also provides enhanced corrosion protection for zinc plated steel, zinc alloy plated steel, and cadmium plated steel that has been chromated with either trivalent chromium or hexavalent chromium conversion coatings.

### DETAILED DESCRIPTION

The invention relates to a coated substrate comprising a corrosion inhibiting composition on a metal substrate or a plated metal surface which can be an article, part, sheet, or other item. The corrosion inhibitor composition comprises a film forming compound and a sulfur containing compound such as a sulfide salt, a thio compound or a derivative of a thio compound.

Dipping or spraying metal articles, parts, etc. with a solution containing only the sulfur containing compounds provides no corrosion protection because the sulfur compounds are readily removed by exposure to the environment. However, it has been found that by sealing, encapsulating, binding, etc. the sulfur containing compounds on the metal substrate or surface with a film forming compound, the sulfur containing compounds are able to perform as inhibitors to corrosion. The metal articles, parts, etc. are preferably zinc, zinc alloy, cadmium, chromated zinc, chromated zinc alloy, chromated cadmium, and plated coatings thereof. The preferred metals alloyed with zinc are iron, tin, nickel, and cobalt. The metal articles, parts, etc. can be fasteners, brackets, shelving, tubing, tools, or parts for automobiles, appliances, bicycles, or furniture, and the like.

Applying thin films of dispersed, emulsified or dissolved waxes, synthetic polymers or inorganic film forming compounds provides very little or limited corrosion protection to metal substrates or surfaces. It is not until sulfur containing compounds are included in the film forming solutions that extensive corrosion protection is achieved.

Curing methods for these thin films which contain a sulfur containing compound may vary in technique based on the type of organic or inorganic film forming compound used and the speed at which a cured coating is needed. A cured coating takes place after sufficient water or solvent has been removed from the film. Air drying as well as heat drying with the heat sources from either conventional thermal furnaces or infrared sources provide sufficient solvent removal and curing for this invention. Curing can also be achieved by using ultra-violet sources. Further additives that aid in the curing process and provide other benefits may be selected from but are not limited to crosslinking agents, photo initiators, ultra-violet stabilizers, infra-red or ultra-violet curing agents, ultra-violet tracers, identifying dyes and pigments. These additives may be added to the coating of the current invention to enhance properties of the organic or inorganic film forming compounds.

The waxes, synthetic polymers, and inorganic film forming compounds of this invention vary widely. They may be dissolved in suitable solvents, dispersed or emulsified in water or made soluble in water via polar functional groups. Examples of suitable waxes are a carnauba wax emulsion, MichemLube 160, a carnauba/paraffin wax emulsion, MichemLube 182, and a paraffin wax emulsion, MichemLube 743, all manufactured by Michelman, Inc. Examples of polyethylene wax emulsions are MichemLube ML 190 and MichemLube 103DI, both also manufactured by Michelman, Inc. Examples of synthetic polymers are urethane polymers such as Neorez R 9637 manufactured by Zeneca Resins and Hauthane HD-2107, a polyester-based urethane dispersion manufactured by C. L. Hauthaway & Sons Corp. Useful acrylic polymers are Rhoplex WL-71 and Acrysol WS-24, acrylic emulsions manufactured by Rohm and Haas Co., and Neocryl A640, a styrenated acrylic manufactured by Zeneca Resins. Acrylic/urethane copolymers can also be used as film formers for this invention and examples include Hybridur 570, an anionically stabilized acrylic-urethane hybrid polymer manufactured by Air Products, and Witcobond A100, a colloidal dispersion of an alloyed aliphatic polyester based urethane and a polyacrylate manufactured by Witco Corp. Zinc and sodium ionomer dispersions of ethylene acrylic acid copolymers such as Acqua 220 and Acqua 240, respectively, manufactured by Michelman also perform well as film formers for this invention.

Examples of inorganic film forming compounds are sodium, or potassium silicates such as Sodium Silicate “N”, a sodium silicate solution manufactured by PQ Corporation, and lithium polysilicate manufactured by Grace Davison under the Ludox tradename, and Nalco 2327, Nalco 1034-A, and Nalco 1060 colloidal silicas manufactured by ONDEO Nalco Company.

The dispersed, emulsified or dissolved waxes and synthetic polymers and inorganic film forming compounds and mixtures thereof of this invention are used in a solution for-spraying or dipping at a concentration generally from about 3 g/l to over 200 g/l, desirably from about 5 g/l to about 100 g/l, with the preferred amount of about 7 g/l to about 50 g/l of solution. The solutions also. have dissolved therein sulfur containing compounds in the amount generally from about 1 to about 100 g/l, desirably from about 1.5 g/l to about 75 g/l, with the preferred amount of about 2 to about 50 g/l of solution. The preferred solvent for these solutions is water. Hydrocarbon solvents can also be utilized such as mineral spirits, methyl alcohol, ethyl alcohol, isopropyl alcohol, and glycol ethers. The films formed from these preferred solutions are effective corrosion inhibitors even at thicknesses of less than about 0.5 microns.

The sulfur containing compounds of this invention are wide in range and are generally considered to be sulfides and thio compounds. The term sulfide in most cases indicates at least one divalent sulfur linkage or bond present in the compound that is not directly adjacent to an oxygen atom. It includes divalent sulfur associated with metallic salts, ammonium salts, organic derivatives and salts of organic derivatives, or additional divalent sulfur atoms, or mixtures thereof. The organic derivatives may include substituted or unsubstituted aliphatic, aromatic, or heterocyclic groups, such as substituted or unsubstituted alkyl or alkenyl groups having from 1 to about 6 carbon atoms, phenyl, or vinyl groups and the like.

The prefix thio in most cases indicates that sulfur has replaced oxygen in a compound. Examples of the thio compounds of this invention include 1) thiourea and its derivatives, 2) benzothiazole and its derivatives, 3) salts of dialkyldithiocarbamides, 4) thiosulfate salts, 5) trithiocyanuric acid and its salts, 6) thiocyanate salts, 7) tetrathionate salts, and 8) 0-alkylxanthic acids and derivatives thereof.

The thiourea derivatives have the following general formula:

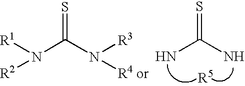

where R¹, R², and R³ independently, include hydrogen, an alkyl containing from 1 to about 6 carbon atoms such as methyl, ethyl, or propyl; acetyl, or allyl, and the like, R⁴ is hydrogen, an alkyl containing from 1 to about 6 carbon atoms such as methyl, ethyl, or propyl; acetyl, allyl, or —NH₂, and the like, and R⁵ is ethylene, n-propylene, or isopropylene, and the like.

The benzothiazole derivatives have the following general formula:

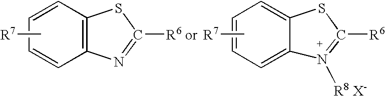

where R⁶ is hydrogen, an alkyl containing from 1 to about 6 carbon atoms such as methyl, ethyl, propyl, or isopropyl; —SH, —SCH₂CH₂CH₂SO₃Na, —NH₂, —NHCH₃ or —N(CH₃)₂, and the like,

and R⁷ is hydrogen, an alkyl containing from 1 to about 6 carbon atoms such as methyl, ethyl, or propyl; or —SO₂CH₃, and the like, and R⁸ is an alkyl containing from 1 to about 6 carbon atoms such as methyl, ethyl, or propyl; allyl, carboxymethyl, or carboxyethyl, and the like, and X is an anion comprising Cl, I, Br, F, or sulfate, and the like.

The dialkyldithiocarbamic acids of this invention have the following formula:

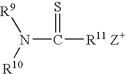

where R⁹ and R¹⁰, independently, are hydrogen, an alkyl containing from 1 to about 6 carbon atoms such as methyl, ethyl, or propyl; and the like, R¹¹ is —S⁻, or —SCH₂CH₂CH₂SO₃⁻, and Z is hydrogen, ammonium, sodium, or potassium, and the like.

The thiosulfate salts of this invention are preferably water soluble compounds containing the base thiosulfate derivative S₂O₃². Salts employed herein include alkali metal, alkaline earth metal, or ammonium salts or mixtures thereof.

The salts of the trithiocyanuric acid, thiocyanate, and tetrathionate compounds of this invention include alkali metal, alkaline earth metal, or ammonium salts or mixtures thereof.

The O-alkylxanthic acid derivatives of this invention have the following general formula:

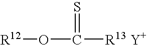

Where R¹² is an alkyl group containing from 1 to about 6 carbon atoms such as methyl, ethyl, or propyl and R¹³ is —S^{—}, or and −SCH₂CH₂CH₂SO₃⁻, and Y is hydrogen, ammonium, sodium, or potassium, and the like.

As noted above, the sulfur containing compounds such as the sulfide and the thio compounds are used in a concentration from about 1 g/l to about 100 g/l, desirably from about 1.5 g/l to about 75 g/l, with a preferred range from about 2 g/l to about 50 g/l of solution. They may be dissolved directly into the wax, synthetic polymer, or inorganic film forming solution or may be dissolved separately in a suitable solvent such as water, ethyl alcohol and the like before adding to the wax or synthetic polymer solution.

The preferred sulfide salts include ammonium sulfide, sodium sulfide, potassium sulfide, sodium tetrasulfide, sodium hydrosulfide, and alkyl substituted sulfides such as Bis-(sodium sulfopropyl)-disulfide which is manufactured by Raschig Corp. under the trade name SPS.

The preferred thio compounds include thiourea, 1,3-dimethylthiourea, ethylenethiourea, 1 -ethyl-2-thiourea, N-acetylthiourea, allylthiourea, thiosemicarbazide, 4-ethyl-3-thiosemicarbazide, 4-methyl-3-thiosemicarbazide, 2-aminobenzothiazole, 2-mercaptobenzothiazole, 3-(benzothiazolyl-2-mercapto)-propylsulfonic acid sodium salt, 3-carboxymethyl benzothiazolium bromide, 2-amino-6-methyl sulfonyl benzothiazole, salts of dimethyidithiocarbamic acid and diethyidithiocarbamic acid, N,N-dimethyl-dithiocarbamyl propylsulfonic acid sodium salt, trithiocyanuric acid or an ammonium salt thereof, water soluble thiosulfate salts, thiocyanate salts, tetrathionate salts, O-ethylxanthic acid potassium salt, (O-ethylthiocarbonato)-S-(3-sulfopropyl)-ester potassium salt, and 3-(amidinothio)-1-propanesulfonic acid. The preferred salts are ammonium salts when organic film forming compounds are used. When inorganic film forming compounds are used such as sodium silicate any water soluble salt such as ammonium, sodium, and potassium may be used. Of the above listed compounds, 3-(benzothiazolyl-2-mercapto)-propylsulfonic acid sodium salt, N,N-dimethyl-dithiocarbamyl propylsulfonic acid sodium salt, (O-ethylthiocarbonato)-S-(3-sulfopropyl)-ester potassium salt, and 3-(amidinothio)-1-propanesulfonic acid are all manufactured by Raschig Corp. under the trade names ZPS, DPS, OPX, and UPS respectively.

The present invention will be better understood by reference to the following examples which serve to illustrate, but not to limit the invention.

### EXAMPLES

Steel parts to be tested were prepared in the following manner.

Commercially produced zinc plated steel, one half inch thick, one hole electrical conduit straps manufactured by Scott Fetzer Co. in Cleveland, Ohio were stripped in 30% hydrochloric acid and rinsed.

The straps were then barrel plated in a bright ammonium chloride/potassium chloride zinc plating bath to achieve a plating thickness of 7-8 microns on each part.

In some of the tests the parts were subsequently dipped in solutions containing film forming compounds and sulfur containing compounds of this invention. Desirably, the thio containing compounds can be dissolved directly in solutions containing the film forming compounds. Alternatively, they can be dissolved separately in an appropriate solvent such as water before combining them with the film forming compounds. In either situation, pH adjustments may be required to facilitate solution formation. Parts were also dipped in solutions containing only the film forming compound or solutions containing only the sulfur containing compounds for comparison purposes.

Additional tests were performed wherein the zinc plated parts were dipped for 15 seconds in the trivalent chromate solution of Table A, rinsed with water and subsequently dipped in solutions of film forming compounds and sulfur containing compounds of this invention.

Again, additional tests were performed wherein the zinc plated, chromated parts were dipped in solutions containing only the film forming compounds or solutions of only the sulfur containing compounds for comparison purposes.

As a final comparison, parts were tested after zinc plating only, and after zinc plating and chromating only, to show the effects of dipping the parts in the solutions of this invention.

In all cases before salt spray testing, the parts were allowed to dry overnight at ambient temperature after dipping. The parts were then tested in a salt spray chamber according to the provisions ASTM B-117.

TABLE A
Compositon Of Trivalent Chromating Solution

| | | |
|---|---|---|
| Trivalent Chromium ion | 0.5 | g/l |
| Ammonium Bifluoride | 0.75 | g/l |
| Sulfuric Acid | 0.25 | g/l |
| Nitric Acid | 4.5 | g/l |
| Water | 993 | g/l |

Table 1 shows the results of salt spray tests of parts that were zinc plated but not chromated, and subsequently dipped in the solutions indicated. Dipping solutions were made up so that the film forming organic compound was approximately 40 g/l except in the case of “N” sodium silicate which was approximately 15 g/l. In all cases the thio containing compound was about 5 g/l.

TABLE 1

| | | White | White |
|---|---|---|---|
| | Sulfide, Thio Compound or | Corrosion | Corrosion |
| Film Forming | Derivative of a Thio | After 7 | After 24 |
| Compound | Compound | Hours | Hours |
| None | None | 45% | 90% |
| None | Trithiocyanuric Acid | 45% | 90% |
| None | 2-Mercaptobenzothiazole | 45% | 90% |
| None | 1,3-Dimethylthiourea | 45% | 90% |
| None | 3-(Carboxymethyl)- | 45% | 90% |
| | Benzothiazolium Bromide | | |
| None | Ammonium Thiosulfate | 45% | 90% |
| Neorez R9637 | None | 40% | 90% |
| Neorez R9637 | Triammonium Salt of | 25% | 50% |
| | Trithiocyanuric Acid | | |
| Rhoplex WL-71 | None | 40% | 80% |
| Rhoplex WL-71 | 2-Mercaptobenzothiazole | 15% | 50% |
| Acrysol WS-24 | None | 40% | 80% |
| Acrysol WS-24 | Ammonium Thiosulfate | 5% | 5% |
| Acrysol WS-24 | Sodium Sulfide | 5% | 40% |
| Witcobond A100 | None | 30% | 80% |
| Witcobond A100 | Triammonium Salt of | 20% | 55% |
| | Trithiocyanuric Acid | | |
| Michelman ML 190 | None | 20% | 55% |
| Michelman ML 190 | Thiourea | 5% | 15% |
| Acqua 220 | None | 30% | 70% |
| Acqua 220 | 4-Methyl-3- | 15% | 35% |
| | Thiosemicarbazide | | |
| “N” Sodium Silicate | None | 5% | 15% |
| “N” Sodium Silicate | Sodium Thiosulfate | 5% | 5% |
| Acrysol WS-24 | Ammonium Thiocyanate | 10% | 25% |
| Acrysol WS-24 | Sodium Tetrathionate | 5% | 20% |
| Acrysol WS-24 | O-Ethylxanthic Acid | 10% | 30% |
| | Potassium Salt | | |
| Acrysol WS-24 | 3-(Amidinothio)-1- | 10% | 25% |
| | propanesulfonic acid | | |

Table 2 shows the results of salt spray tests of parts that were zinc plated and chromated in the trivalent chromate in Example 1, then dipped in the solutions indicated. Dipping solutions were made up so that the film forming compound was approximately 40 g/l. In all cases the thio containing compound was approximately 5 g/l.

TABLE 2

| | | White |
|---|---|---|
| | Sulfide, Thio Compound or | Corrosion |
| Film Forming | Derivative of a Thio | After 72 |
| Compound | Compound | Hours |
| None | None | 80% |
| None | Thiourea | 80% |
| None | Acetylthiourea | 80% |
| None | 4-Methyl-3-Thiosemicarbazide | 80% |
| None | 1-Ethyl-2-Thiourea | 80% |
| None | 1,3-Dimethylthiourea | 80% |
| None | Trithiocyanuric Acid | 80% |
| None | 2-Mercaptobenzothiazole | 80% |
| None | Ammonium Thiosulfate | 80% |
| None | Allylthiourea | 80% |
| None | Ethylenethiourea | 80% |
| NeoCryl A640 | None | 80% |
| NeoCryl A640 | Thiourea | 6% |
| NeoRez R9637 | None | 80% |
| NeoRez R9637 | Acetylthiourea | 4% |
| Rhoplex 71 | None | 80% |
| Rhoplex 71 | 4-Methyl-3-Thiosemicarbazide | 7% |
| Hybridur 570 | None | 60% |
| Hybridur 570 | 1-Ethyl-2-Thiourea | 2% |
| Witcobond A100 | None | 60% |
| Witcobond A100 | 1,3-Dimethylthiourea | 12% |
| Rhoplex WL 71 | Trithiocyanuric Acid | 18% |
| NeoRez R9637 | 2-Mercaptobenzothiazole | 25% |
| Hybridur 570 | Ammonium Thiosulfate | 15% |
| Acqua 220 | Allylthiourea | 10% |
| Nalco 1034-A | None | 20% |
| Nalco 1034-A | Thiourea | 5% |
| Neorez R9637 | Ethylenethiourea | 15% |
| Acrysol WS-24 | None | 60% |
| Acrysol WS-24 | Sodium Tetrathionate | 20% |
| Acrysol WS-24 | Sodium Sulfide | 25% |
| Nalco 1060 | None | 18% |
| Nalco 1060 | Ammonium Thiocyanate | 10% |
| Neorez R9637 | O-Ethylxanthic Acid | 15% |
| | Potassium Salt | |

As can be seen from Tables 1 and 2, a coating comprising the combination of a film forming compound and a sulfur containing compound provides excellent corrosion protection on a zinc metal surface and a chromated zinc metal surface, whereas the film forming compounds alone provide only minimal corrosion protection and the sulfur containing compounds alone do not provide any corrosion protection at all.

While in accordance with the patent statutes the best mode and preferred embodiment have been set forth, the scope of the invention is not intended to be limited thereto, but only by the scope of the attached claims.

What is claimed is:

1. A coated substrate comprising:
a corrosion inhibiting composition on the substrate; said composition comprising a film forming compound, and a sulfide salt or a thio compound or a derivative of a thio compound; and
said substrate comprising a metal or a plated metal surface.

2. A coated substrate according to claim 1, wherein said metal comprises zinc, zinc alloy, cadmium, chromated zinc, chromated zinc alloy, or chromated cadmium.

3. A coated substrate according to claim 2, wherein said corrosion inhibiting composition comprises a film less than about 0.5 microns in thickness.

4. A coated substrate according to claim 2, wherein said corrosion inhibiting composition contains at least one additive comprising a crosslinking agent, photoinitiator, ultra-violet stabilizer, infrared or ultra-violet curing agent, ultra-violet tracer, identifying dye, or a pigment, or combinations thereof.

5. A coated substrate according to claim 2, wherein said corrosion inhibiting composition is cured.

6. A coated substrate according to claim 2, wherein the sulfide salt comprises ammonium sulfide, sodium sulfide, potassium sulfide, sodium tetrasulfide, sodium hydrosulfide, or Bis-(sodium sulfopropyl)-disulfide, or combinations thereof.

7. A coated substrate according to claim 2, wherein the thio compound is a thiourea compound of the formula: 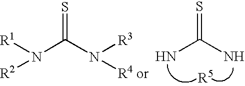
wherein R¹, R², and R³, independently, is hydrogen, an alkyl containing from 1 to about 6 carbon atoms, acetyl, or allyl, wherein R⁴ is hydrogen, an alkyl containing from 1 to about 6 carbon atoms, acetyl, allyl, or —NH₂, and
wherein R⁵ is ethylene, n-propylene, or isopropylene.

8. A coated substrate according to claim 2, wherein the thio compound is a benzothiazole of the formula: 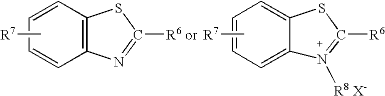
wherein R⁶ is hydrogen, an alkyl containing from 1 to about 6 carbon atoms, —SH, —SCH₂CH₂CH₂SO₃Na, —NH₂, —NHCH₃ or —N(CH₃)₂,
and R⁷ is hydrogen, an alkyl containing from 1 to about 6 carbon atoms, or —SO₂CH₃,
R⁸ is an alkyl containing from 1 to about 6 carbon atoms, allyl, carboxymethyl, or carboxyethyl, and
X is an anion comprising Cl, I, Br, F, or sulfate.

9. A coated substrate according to claim 2, wherein the thio compound is a dialkyldithiocarbamic acid of the formula: 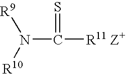
wherein R⁹ and R¹⁰, independently, is hydrogen, or an alkyl containing from 1 to about 6 carbon atoms, R¹¹is —S⁻ or —SCH₂CH₂CH₂SO₃⁻, and
Z is hydrogen, ammonium, sodium, or potassium.

10. A coated substrate according to claim 2, wherein the thio compound is trithiocyanuric acid or a salt thereof; or a thiocyanate salt; or a tetrathionate salt; wherein the salt portion is an alkali metal, and an alkaline earth metal, or ammonium; or O-alkylxanthic acid or a derivative thereof; or combinations thereof.

11. A coated substrate according to claim 2, wherein the thio compound is a thiosulfate salt.

12. A coated substrate according to claim 2, wherein the thio compound comprises thiourea, 1,3-dimethylthiourea, ethylenethiourea, 1-ethyl-2-thiourea, N-acetylthiourea, allylthiourea, thiosemicarbazide, 4-ethyl-3-thiosemicarbazide, 4-methyl-3-thiosemicarbazide, 2-aminobenzothiazole, 2-mercaptobenzothiazole, 3-(benzothiazolyl-2-mercapto)-propylsulfonic acid sodium salt, 3-carboxymethyl benzothiazolium bromide, 2-amino-6-methyl sulfonyl benzothiazole, salts of dimethyldithiocarbamic acid and diethyidithiocarbamic acid, N,N-dimethyldithiocarbamyl propylsulfonic acid sodium salt, trithiocyanuric acid or an ammonium salt thereof, water soluble thiosulfate salts, thiocyanate salts, tetrathionate salts, O-ethylxanthic acid potassium salt, (O-ethylthiocarbonato)-S-(3-sulfopropyl)-ester potassium salt, or 3-(amidinothio)-1-propanesulfonic acid, or combinations thereof.

13. A coated substrate according to claim 7, wherein the film forming compound comprises a carnauba wax emulsion, carnauba/paraffin wax emulsion, paraffin wax emulsion, polyethylene wax emulsion, urethane polymer, polyester-based urethane dispersion, acrylic polymer, acrylic copolymer, an ionomer dispersion of ethylene acrylic acid copolymer and sodium silicate, potassium silicate, lithium polysilicate, or colloidal silica.

14. A coated substrate according to claim 11, wherein the film forming compound comprises a carnauba wax emulsion, carnauba/paraffin wax emulsion, paraffin wax emulsion, polyethylene wax emulsion, urethane polymer, polyester-based urethane dispersion, acrylic polymer, acrylic copolymer, an ionomer dispersion of ethylene acrylic acid copolymer, sodium silicate, potassium silicate, lithium polysilicate, or colloidal silica.

15. A coated substrate according to claim 12, wherein the film forming compound comprises a carnauba wax emulsion, carnauba/paraffin wax emulsion, paraffin wax emulsion, polyethylene wax emulsion, urethane polymer, polyester-based urethane dispersion, acrylic polymer, acrylic copolymer, an ionomer dispersion of ethylene acrylic acid copolymer, sodium silicate, potassium silicate, lithium polysilicate, or colloidal silica.

16. A solution for applying a corrosion inhibiting composition on a metal surface comprising;
a film forming compound comprising a wax, synthetic polymer, sodium silicate, potassium silicate, lithium polysilicate, or colloidal silica, or mixtures thereof; and a sulfide salt or a thio compound or a derivative of a thio compound.

17. A solution according to claim 16, further comprising a crosslinking agent, photoinitiator, ultra-violet stabilizer, infrared or ultra-violet curing agent, ultra-violet tracer, or an identifying dye or pigment, or combinations thereof.

18. A solution according to claim 16, wherein said solution contains water.

19. A solution according to claim 18, wherein the sulfide salt comprises ammonium sulfide, sodium sulfide, potassium sulfide, sodium tetrasulfide, sodium hydrosulfide, or Bis-(sodium sulfopropyl)-disulfide, or combinations thereof.

20. A solution according to claim 18, wherein said thio compound is thiourea or a derivative thereof, a benzothiazole or a derivative thereof, a salt of dialkyldithiocarbonate, or combinations thereof.

21. A solution according to claim 18, wherein said thio compound is a thiourea compound of the formula: 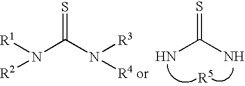
wherein R¹, R², and R³, independently, is hydrogen, an alkyl containing from 1 to about 6 carbon atoms, acetyl, or allyl,
wherein R⁴ is hydrogen, an alkyl containing from 1 to about 6 carbon atoms, acetyl, allyl, or —NH₂, and
wherein R⁵ is ethylene, n-propylene, or isopropylene.

22. A solution according to claim 18, wherein the thio compound is a benzothiazole of the formula: 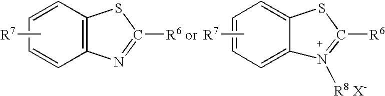
wherein R⁶ is hydrogen, an alkyl containing from 1 to about 6 carbon atoms, —SH, —SCH₂CH₂CH₂SO₃Na, —NH₂, —NHCH₃ or —N(CH₃)₂,
and R⁷ is hydrogen, an alkyl containing from 1 to about 6 carbon atoms, or —SO₂CH₃,
R⁸ is an alkyl containing from 1 to about 6 carbon atoms, allyl, carboxymethyl, or carboxyethyl, and
X is an anion comprising Cl, I, Br, F, or sulfate.

23. A solution according to claim 18, wherein said thio compound is a dialkyldithiocarbamic acid of the formula: 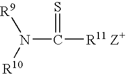
wherein R⁹ and R¹⁰, independently, is hydrogen, or an alkyl containing from 1 to about 6 carbon atoms, R¹¹ is —S⁻ or —SCH₂CH₂CH₂SO₃⁻, and
Z is hydrogen, ammonium, sodium, or potassium.

24. A solution according to claim 18, wherein the thio compound is trithiocyanuric acid, or a thiocyanate salt or a tetrathionate salt wherein the salt portion is an alkali metal, and an alkaline earth metal, or ammonium, or O-alkylxanthic acid or a derivative thereof, or combinations thereof.

25. A solution according to claim 18, wherein the thio compound is a thiosulfate salt.

26. A solution according to claim 18, wherein the thio compound comprises thiourea, 1,3-dimethylthiourea, ethylenethiourea, 1-ethyl-2-thiourea, N-acetylthiourea, allylthiourea, thiosemicarbazide, 4-ethyl-3-thiosemicarbazide, 4-methyl-3-thiosemicarbazide, 2-aminobenzothiazole, 2-mercaptobenzothiazole, 3-(benzothiazolyl-2-mercapto)-propylsulfonic acid sodium salt, 3-carboxymethyl benzothiazolium bromide, 2-amino-6-methyl sulfonyl benzothiazole, salts of dimethyldithiocarbamic acid and diethyldithiocarbamic acid, N,N-dimethyldithiocarbamyl propylsulfonic acid sodium salt, trithiocyanuric acid or an ammonium salt thereof, water soluble thiosulfate salts, thiocyanate salts, tetrathionate salts, O-ethylxanthic acid potassium salt, (O-ethylthiocarbonato)-S-(3-sulfopropyl)-ester potassium salt, or 3-(amidinothio)-1-propanesulfonic acid, or combinations thereof.

27. A solution according to claim 25, wherein the film forming compound comprises a carnauba wax emulsion, carnauba/paraffin wax emulsion, paraffin wax emulsion, polyethylene wax emulsion, urethane polymer, polyester-based urethane dispersion, acrylic polymer, acrylic copolymer, an ionomer dispersion of ethylene acrylic acid copolymer and sodium silicate, potassium silicate, lithium polysilicate, or colloidal silica.

28. A solution according to claim 26, wherein the film forming compound comprises a carnauba wax emulsion, carnauba/paraffin wax emulsion, paraffin wax emulsion, polyethylene wax emulsion, urethane polymer, polyester-based urethane dispersion, acrylic polymer, acrylic copolymer, an ionomer dispersion of ethylene acrylic acid copolymer, sodium silicate, potassium silicate, lithium polysilicate, or colloidal silica.

29. A solution according to claim 18, wherein the amount of the film-forming compound is from about 3 g/l to about 200 g/l of solution, and wherein the amount of the sulfide salt or thio compound or derivative of a thio compound is from about 1 g/l to about 100 g/l of solution.

30. A solution according to claim 28, wherein the amount of the film-forming compound is from about 7 g/l to about 50 g/l of solution, and wherein the amount of the sulfide salt or thio compound or derivative of a thio compound is from about 2 g/l to about 50 g/l of solution.
